(19) United States
(12) Patent Application Publication
(10) Pub. No.: US 2004/0173689 A1
(43) Pub. Date: Sep. 9, 2004

(54) Centralized electrical power control system utilizing PLC or RF modem

(76) Inventor: Hoyong Kim, Laguna Hills, CA (US)

Correspondence Address: Eugene Oak, Ph.D.,J.D., Patent Attorney, 610 S. Van Ness Ave., Los Angeles, CA, 90005, US

(21) Appl. No.: 10/377,550

(22) Filed: Mar. 3, 2003

(51) Int. Cl. G05D 23/00

(52) U.S. Cl. 236/47

(57) ABSTRACT

A novel centralized power on/off control system for motel is comprised of, including but not limited to; 1) a PLC (Power Line Carrier) or RF (Radio Frequency) modem connected to a personal computer on the front desk of the motel, 2) PLC or RF modems in each rooms, 3) power relays connected to the PLC or RF modems in each room. A 340 KHz “ON” signal is transmitted from the main personal computer to the PLC modem installed in each room utilizing 60 Hz 110V power line as the carrier. For RF modem 900 MHz/2.4 GHz radio frequency is utilized for “ON” signal.

### BACKGROUND OF THE INVENTION

Many of the guests staying in a motel room want to turn on the heater or the air conditioner while they go out for a short time. However, the door-key controlled power supplying system automatically turns off the power when the guest go out of the room regardless of the time interval. It is purpose of this invention to provide a centralized power control system for motels which can satisfy both of the owner of the motel and their guests.

1. Field of the invention

The present invention relates to a centralized electrical power control system for motels utilizing PLC or RF modem.

2. Description of the Prior Art

U.S. Pat. No. 5,305,952 to Hannarong, U.S. Pat. No. 4,424,453 to Balls, et al. illustrates a key-operated device for saving electrical energy of a hotel room. The key to operate the device is the same key required for opening the door. When the key is removed from the device the power supply to the electrical devices is disconnected. It is impossible for the guests to leave the room for short period without turning off the electrical equipments unless they have two set of key or open the door.

U.S. Pat. No. 5,682,949 to Ratcliffe , et al. describes a microprocessor based thermostats energy management system for occupied room. The system automatically limits energy usage in unoccupied rooms.

U.S. Pat. No. 4,107,466 to Churchill, U.S. Pat. No. 4,174,064 to Pratt, Jr. and U.S. Pat. No. 4,021,615 to James, et al. illustrate apparatus for turning off electrical power in rooms of a building having a private automatic branch exchange telephone system. Power is disconnected as soon as the guests leave the room.

U.S. Pat. No. 4,058,740 to Dalton, et al. illustrates an electrical energy controlling system for a motel room, operates based on the status of door and latch. When the door is closed but the inside latch unlatched, the electrical devices will turn off. Guests can not leave the room even for short period without opening the door if they want to turn on the electrical equipments.

None of the prior arts illustrates a centralized power control system utilizing PLC modem for a motel room allowing local control by the guests.

### SUMMARY OF THE INVENTION

It is the purpose of this invention to provide a novel centralized power on/off control system for motel which is comprised of, including but not limited to; 1) a PLC (Power Line Carrier) or RF (Radio Frequency) modem connected to a personal computer on the front desk of the motel, 2) PLC or RF modems in each rooms, 3) power relays connected to the PLC or RF modems in each room. A 340 KHz “ON” signal is transmitted from the main personal computer to the PLC modem installed in each room utilizing 60 Hz 110V power line as the carrier. For RF modem 900 MHz/2.4 GHz radio frequency is utilized for “ON” signal. The PLC or RF modem in each room activates the power relay in each room to turn “ON” the electrical equipments such as the heater or the air conditioner in each room. Guests in each room can turn “ON” and “OFF” the electrical equipment only when the main personal computer in front desk of the motel gives “ON” signal to the PLC or RF modem of the room. If the main personal computer gives “OFF” signal to the PLC or RF modem of certain room, the guests in that room cannot turn “ON” the electrical equipments. The PLC or RF modems have encoder and decoder to communicate with the specifically identified PLC or RF modem in each room. Signals are exchanged at given time intervals between the modems in each room and the main personal computer to check the malfunction of the modems. If the PLC or RF modem in a room does not respond for some period, the “fail safe” function is activated to allow the guests in the room turn “ON” and “OFF” the electrical equipments.

### BRIEF DESCRIPTION OF THE DRAWINGS

FIG. 1 is a block diagram of PLC power control system of this invention.

FIG. 2 is a block diagram of RF power control system of this invention.

### DETAILED DESCRIPTION OF THE PREFERRED EMBODIMENT

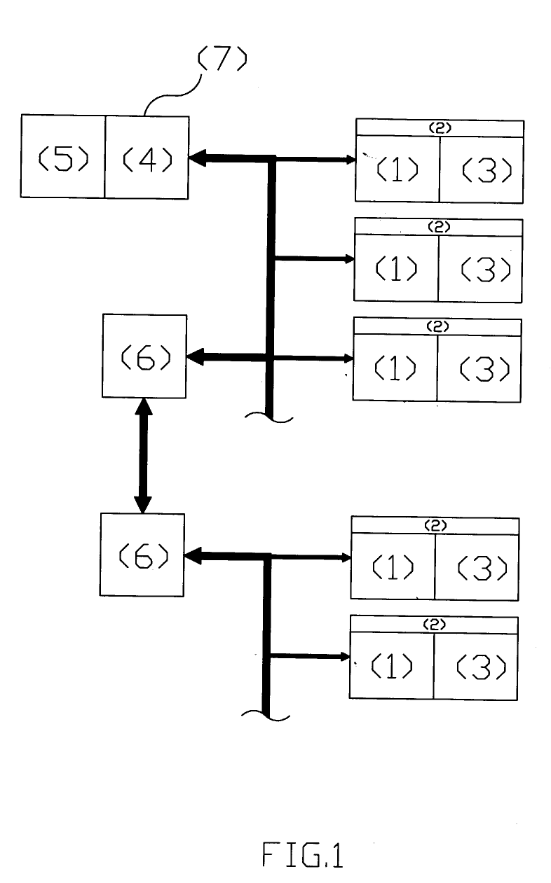

FIG. 1 is a layout of temperature control system of this invention. A PLC (Power Line Carrier) modem (1) is installed in each room (2) coupled with a power relay (3). The PLC modem (1) in each room is connected to the PLC modem (4) connected to the PC (Personal Computer) controller (5). Rooms located at remote area are connected by repeaters (6).

An “ON” signal, 340 KHz, generated from the PC controller (5), is transferred to the PLC modem (1) in each room through the PLC modem (4) connected to the PC controller (5), utilizing 60 Hz 110V power as the carrier The PLC modem (1) in each room activate power relay (3) to supply electrical power to the electrical equipments of such as air-conditioner, heater, light, audio and television.

Guests in each room can turn on and off the electrical equipments only when the “ON” signal is provided to the designating room by the PC controller (5) in the front desk of the motel. If the PC controller (5) does not provide the “ON” signal, the main power in that room is off and the guest cannot turn on the electrical equipments.

Each PLC modem (1) and (4) has encoder and decoder to check the ID of the counter part PLC modem and communicate with only designated PLC modem. The PLC modem (4), connected to the PC (Personal Computer) controller (5), periodically sends out “Check” signal to every PLC modem (1) in each room to check the operational status. The PLC modem (1) in each room sends out counter signal to the PLC modem (4) if the PLC modem in the room works normally.

If the PLC modem (1) in each room does not respond or send out normal signal to the PLC (4) connected to the PC controller for pre-set time interval, the PC (7) recognize it as abnormal and activate “Fail Safe” function to allow the guests in the room turn on and off the electrical equipments.

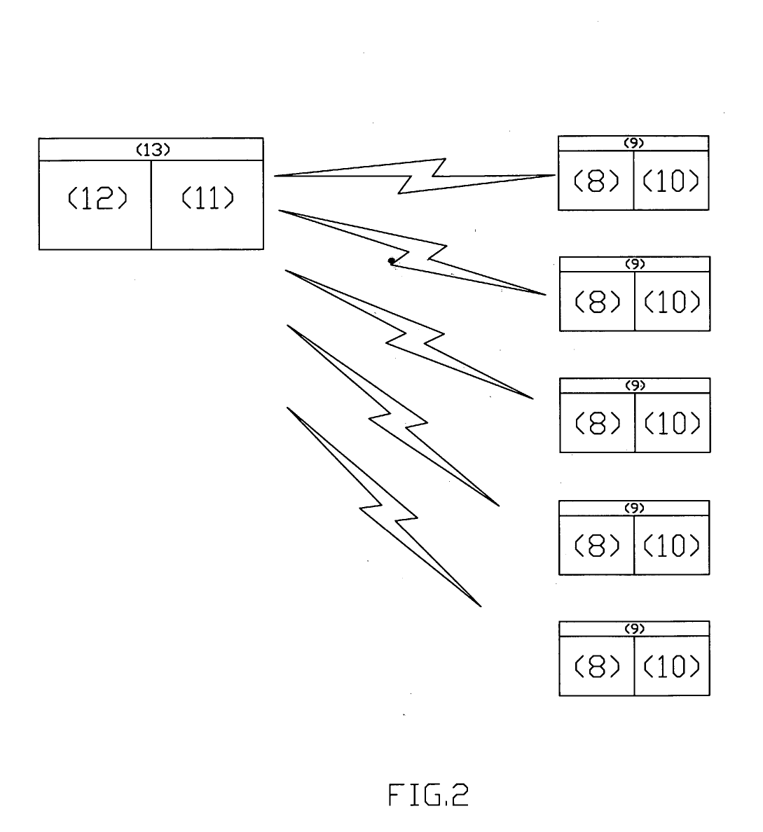

FIG. 2 is a block diagram of RF power control system of this invention. An RF(Radio Frequency) modem (8) is installed in each room (9) coupled with a power relay (10). The RF modem (8) in each room is connected to the RF modem (11) connected to the PC (Personal Computer) controller (12).

An “ON” signal, 900 MHz or 2.4 GHz, generated from the PC controller (12), is transferred to the RF modem (8) in each room through the RF modem (11) connected to the PC controller (12). The PLC modem (8) in each room (9) activate power relay (10) to supply electrical power to the electrical equipments of such as air-conditioner, heater, light, audio and television.

Guests in each room can turn on and off the electrical equipments only when the “ON” signal is provided to the designating room by the PC controller (12) in the front desk of the motel. If the PC controller (12) does not provide the “ON” signal, the main power in that room is off and the guest cannot turn on the electrical equipments.

Each RF modem (8) and (11) has encoder and decoder to check the ID of the counter part RF modem and communicate with only designated RF modem. The RF modem (11), connected to the PC (Personal Computer) controller (12), periodically sends out “Check” signal to every RF modem (8) in each room to check the operational status. The RF modem (8) in each room sends out counter signal to the RF modem (11) if the RF modem in the room works normally.

If the RF modem (8) in each room does not respond or send out normal signal to the RF (11) connected to the PC controller for pre-set time interval, the PC (13) recognize it as abnormal and activate “Fail Safe” function to allow the guests in the room turn on and off the electrical equipments.

The PLC or RF modem power control system of this invention is easily installed by 1) connecting ID installed PLC or RF modem and relay to the consents for heater and air-conditioner and 2) connects the PLC or RF modem equipped PC.

What is claimed is:

1. A novel centralized power on/off control system for motel with additional function of manual on/off by the guests in a room, comprising; 1) a PLC(Power Line Carrier) or an RF(Radio Frequency) modem connected to a personal computer in the front desk of a motel; 2) PLC or RF modems in each room; 3) power relays in each room, which communicate each other with 340 KHz “ON” signal utilizing 60 Hz 110V power line as the carrier or 900 MHz or 2.4 GHz radio frequency.

2. The power line modem in each room, in claim 1, activates the power relay in each room to turn “ON” the electrical equipments.

3. The RF modem in each room, in claim 1, activates the power relay in each room to turn “ON” the electrical equipments.

4. The additional function of manual on/off by the guest in a room, in claim 1, is in active mode when the power in each room is “ON” by the personal computer in the front desk.

5. The additional function of manual on/off by the guest in a room, in claim 1, is in active mode when the PLC or RF modem does not work.
